(19) United States
(12) Patent Application Publication
(10) Pub. No.: US 2010/0153957 A1
(43) Pub. Date: Jun. 17, 2010

(54) SYSTEM AND METHOD FOR MANAGING THREAD USE IN A THREAD POOL

(75) Inventor: Tong XU, Westford, MA (US)

Correspondence Address: Christopher & Weisberg, P.A., 200 East Las Olas Boulevard, Suite 2040, Fort Lauderdale, FL, 33301, US

(73) Assignee: SENSORMATIC ELECTRONICS CORPORATION, Boca Raton, FL (US)

(21) Appl. No.: 12/335,893

(22) Filed: Dec. 16, 2008

(51) Int. Cl. G06F 9/46

(52) U.S. Cl. 718/102

(57) ABSTRACT

A method and system for managing a thread pool of a plurality of first type threads and a plurality of second type threads in a computer system using a thread manager, specifically, a method for prioritizing, cancelling, balancing the work load between first type threads and second type threads, and avoiding deadlocks in the thread pool. A queue stores a first type task and a second type task, the second type task being executable by at least one of the plurality of second type threads. The availability of at least one of the plurality of first type threads is determined, and if none are available, the availability of at least one of the plurality of second type threads is determined. An available second type thread is selected to execute the first type task.

### CROSS-REFERENCE TO RELATED APPLICATION

n/a

### STATEMENT REGARDING FEDERALLY SPONSORED RESEARCH OR DEVELOPMENT

n/a

### BACKGROUND OF THE INVENTION

1. Field of the Invention

The present invention relates generally to a system and method for managing threads in a computing system, and more specifically to a system and method for prioritizing, cancelling, balancing the work load between non I/O worker threads and I/O completion threads, and eliminating deadlocks in a thread pool.

2. Description of the Related Art

As modern computer systems become more sophisticated, computers with advanced processors have become the norm. These complex processors have the ability to process billions of instructions per second, giving users the ability to run computer programs at a faster rate.

When a user launches a computer program, the computer program starts one or more processes that provide the resources needed for execution. Each process has a virtual address space, executable code, open handles to system objects, a security context, a unique process identifier, environment variables, a priority class, minimum and maximum working set sizes, and at least one thread of execution. Each process is started with a single thread, often called the primary thread. Usually, each process creates a collection of threads, i.e. a thread pool, and uses the threads in the pool to accomplish different tasks.

A thread is not only the entity within a process that can be scheduled for execution, but it is also the basic unit to which the operating system allocates processor time. A thread can execute any part of the process code, including parts currently being executed by another thread. All threads of a process share the process' virtual address space and system resources. In addition, each thread maintains exception handlers, a scheduling priority, thread local storage, a unique thread identifier, and a set of structures that the system uses to save the thread context until it is scheduled. The thread context includes the thread's set of machine registers, the kernel stack, a thread environment block, and a user stack in the address space of the thread's process.

The tasks, i.e. work item requests, which need to be executed by the threads are organized in a queue. Typically, there are many more work item requests than threads. As soon as a thread finishes a work item request, the thread requests the next work item request from the queue. This process will repeat until all work item requests have been processed.

Depending on the type of work item request, the work item request is assigned to either a non I/O worker thread or to an I/O completion thread. A non I/O worker thread is typically a thread that is created for a task that usually has no user interaction. An I/O completion thread typically refers to a thread that processes device inputs/output operations and asynchronous procedure calls. Having special I/O completion threads dedicated to I/O tasks allows non I/O worker threads to be free for other tasks while lengthy I/O operations take place.

The size of the thread pool refers to the number of threads created. The threads in the thread pool look at the queue to see if there are work requests waiting to be assigned. If there is nothing in the queue, the threads immediately sleep, waiting for jobs.

A non I/O work item request in the queue waits to be executed by a non I/O worker thread. Similarly, an I/O work item request waits to be executed by an I/O completion thread. An exemplary system may have 25 non I/O worker threads and 1000 I/O completion threads, for a total of 1025 threads. If a program queues 30 non I/O work item requests, 25 work item requests will be assigned to the free 25 non I/O worker threads. The five left over non I/O work item requests will remain in the queue, waiting for the non I/O worker threads to finish their task. As non I/O worker threads become available, they will request the next non I/O work item request from the queue. Similarly, I/O work item requests are also queued, and wait to be executed by free I/O completion threads.

With the current methods of thread management, a problem may arise if all 25 non I/O worker threads need to perform a task that requires the help of another non I/O worker thread. This will cause all 25 non I/O worker threads to wait for a free non I/O worker thread to become available to help finish the task. This situation may cause a deadlock to occur, given that all non I/O worker threads are busy, and new non I/O work item requests for threads are being sent to the queue to wait. These new non I/O work item requests may never get executed and may wait forever, as all 25 non I/O worker threads are also waiting for free non I/O worker threads. The system may stop working when all the non I/O worker threads are waiting for a free non I/O worker thread, as none will become available.

Another problem with the current framework is that a user may want to cancel a work item request that has been added to the queue, so that the user can send a more urgent task to be executed immediately. Unfortunately, under the current framework, a work item request that has been added to the queue cannot be cancelled. This is the case even if the work item request is waiting in the queue for a free thread. Furthermore, work item requests in the queue cannot be prioritized, and any new urgent tasks have to wait for all other tasks queued ahead to finish. These problems make the current system inconvenient and inefficient. Therefore, what is needed is a system and method for managing threads under software development frameworks such as the .NET framework, in particular, a system and method that manage the workload between non I/O worker threads and I/O completion threads, and support cancellation and prioritization of work item requests.

### BRIEF SUMMARY OF THE INVENTION

The present invention advantageously provides a method and system for managing threads in a computing system. In accordance with one aspect, the present invention determines whether there are non I/O worker threads available in the thread pool to perform a work item request. If no non I/O worker threads are available, the work item request is not queued in the work queue, but instead, the method and system determines whether there are any I/O completion threads available in the thread pool. If an I/O completion thread is available, the work item request is executed by the I/O completion thread. If no threads are available, the work item request is queued in the work item task queue. When a thread in the thread pool becomes available, the status of the work item task queue is established, and if there is a work item request in the work item task queue, the work item request is removed from the work item task queue. The work item request is then ready to be executed by the available thread.

In accordance with one aspect, the present invention provides a method for managing a thread pool. The thread pool has a plurality of first type threads and a plurality of second type threads. A queue stores a first type task and a second type task, the second type task executable by at least one of the plurality of second type threads. The availability of at least one of the plurality of first type threads is determined. If least one of the plurality of first type threads is unavailable, then the availability of at least one of the plurality of second type threads is determined, and at least one available second type thread is selected to execute the first type task.

In accordance with another aspect, the present invention provides a system for managing a thread pool. The thread pool has a plurality of first type threads and a plurality of second type threads. The system has a memory and a processor in data communication with the memory. The memory contains a queue. A first type task, and a second type task are stored in the queue. The second type task is executable by at least one of the plurality of second type threads. The processor determines the availability of at least one of the plurality of first type threads. If at least one of the plurality of first type threads is unavailable, the processor determines availability of at least one of the plurality of second type threads, and selects at least one available second type thread to execute the first type task.

In accordance with yet another aspect, the present invention provides an apparatus for managing a thread pool. The apparatus has a memory and a processor in data communication with the memory. The memory contains a plurality of first type threads and a plurality of second type threads. The processor stores a plurality of first type threads and a plurality of second type threads in the memory. The memory contains a queue. A first type task and a second type task are stored in the queue. The second type task being executable by at least one of the plurality of second type threads. The processor determines the availability of at least one of the plurality of first type threads. If at least one of the plurality of first type threads is unavailable, the processor determines availability of at least one of the plurality of second type threads, and selects at least one available second type thread to execute the first type task.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of a computer system constructed in accordance with the principles of the present invention;

FIG. 2 is a block diagram of an exemplary thread management system constructed in accordance with the principles of the present invention; and

FIG. 3 is a diagram of a thread management process flow of the present invention.

### DETAILED DESCRIPTION OF THE INVENTION

Before describing in detail exemplary embodiments that are in accordance with the present invention, it is noted that the embodiments reside primarily in combinations of apparatus components and processing steps related to implementing a system and method for thread management. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

The present invention advantageously provides a method and system for managing threads in a computing system by first determining whether there are non I/O worker threads available in the thread pool to perform a work item request. If no non I/O worker threads are available, the work item request is not queued in a work queue, but instead, it is determined whether there are any I/O completion threads available in the thread pool. If an I/O completion thread is available, the work item request is executed by the I/O completion thread. If no threads are available, then the work item request is queued in the work item task queue. When a thread in the thread pool becomes available, the status of the work item task queue is established, and if there is a work item request in the work item task queue, the work item request is removed from the work item task queue. The work item request is then ready to be executed by the available thread.

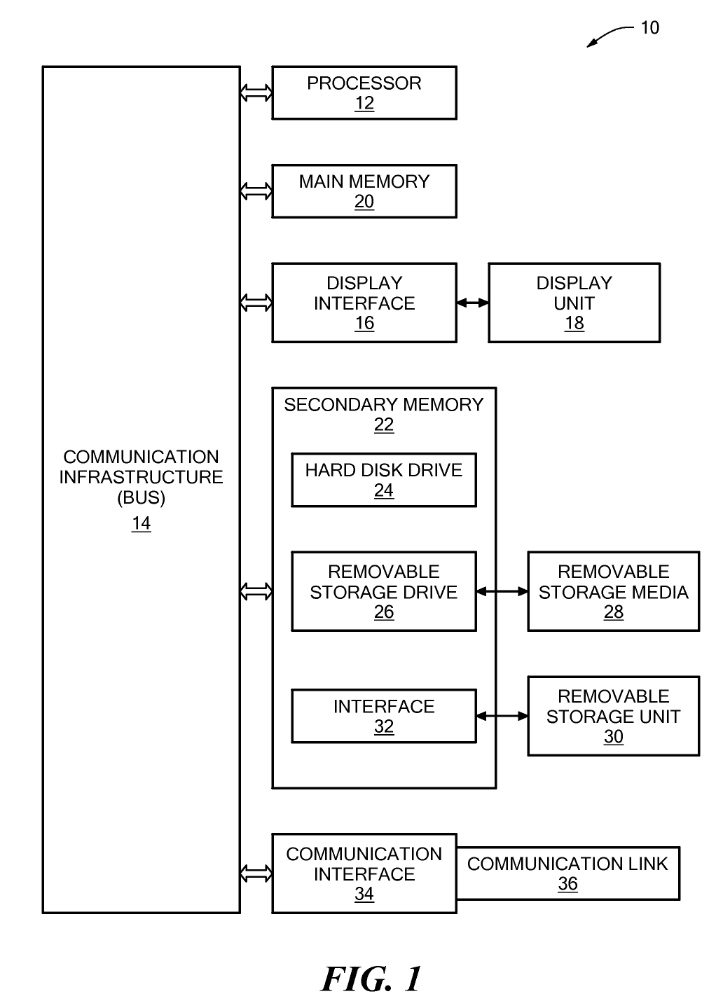

Referring now to the drawing figures in which like reference designators refer to like elements, there is shown in FIG. 1 a diagram of a system constructed in accordance with the principles of the present invention and referred to generally as ‘10’. System 10 includes one or more processors, such as processor 12 programmed to perform the functions described herein. The processor 12 is connected to a communication infrastructure 14, e.g., a communications bus, cross-bar interconnect, network, etc. Various software embodiments are described in terms of this exemplary computer system. After reading this description, it will become apparent to a person of ordinary skill in the relevant art(s) how to implement the invention using other computer systems and/or computer architectures. It is also understood that the capacities and quantities of the components of the architecture described below may vary depending on the device, the quantity of devices to be supported, as well as the intended interaction with the device. For example, access to the thread management method for configuration and management may be designed to occur remotely by web browser. In such case, the inclusion of a display interface and display unit may not be required.

The system 10 can optionally include or share a display interface 16 that forwards graphics, text, and other data from the communication infrastructure 14 (or from a frame buffer not shown) for display on the display unit 18. The computer system also includes a main memory 20, preferably random access memory (“RAM”), and may also include a secondary memory 22. The secondary memory 22 may include, for example, a hard disk drive 24 and/or a removable storage drive 26, representing a floppy disk drive, a magnetic tape drive, an optical disk drive, etc. The removable storage drive 26 reads from and/or writes to a removable storage media 28 in a manner well known to those having ordinary skill in the art. Removable storage media 28, represents, for example, a floppy disk, magnetic tape, optical disk, etc. which is read by and written to by removable storage drive 26. As will be appreciated, the removable storage media 28 includes a computer usable storage medium having stored therein computer software and/or data.

In alternative embodiments, the secondary memory 22 may include other similar means for allowing computer programs or other instructions to be loaded into the computer system and for storing data. Such means may include, for example, a removable storage unit 30 and an interface 32. Examples of such may include a program cartridge and cartridge interface (such as that found in video game devices), flash memory, a removable memory chip (such as an EPROM, EEPROM or PROM) and associated socket, and other removable storage units 30 and interfaces 32 which allow software and data to be transferred from the removable storage unit 30 to other devices.

The system 10 may also include a communications interface 34. Communications interface 34 allows software and data to be transferred to external devices. Examples of communications interface 34 may include a modem, a network interface (such as an Ethernet card), a communications port, a PCMCIA slot and card, wireless transceiver/antenna, etc. Software and data transferred via communications interface/module 34 are in the form of signals which may be, for example, electronic, electromagnetic, optical, or other signals capable of being received by communications interface 34. These signals are provided to communications interface 34 via the communications link (i.e., channel) 36. This channel 36 carries signals and may be implemented using wire or cable, fiber optics, a phone line, a cellular phone link, an RF link, and/or other communications channels.

Of course, system 10 may have more than one set of communication interface 34 and communication link 36. For example, system 10 may have a communication interface 34/communication link 36 pair to establish a communication zone for wireless communication, a second communication interface 34/communication link 36 pair for low speed, e.g., WLAN, wireless communication, another communication interface 34/communication link 36 pair for communication with low speed wireless networks, and still another communication interface 34/communication link 36 pair for other communication.

Computer programs (also called computer control logic) are stored in main memory 20 and/or secondary memory 22. Computer programs may also be received via communications interface 34. Such computer programs, when executed, enable the method and system to perform the features of the present invention as discussed herein. In particular, the computer programs, when executed, enable the processor 12 to perform the features of the corresponding method and system. Accordingly, such computer programs represent controllers of the corresponding device.

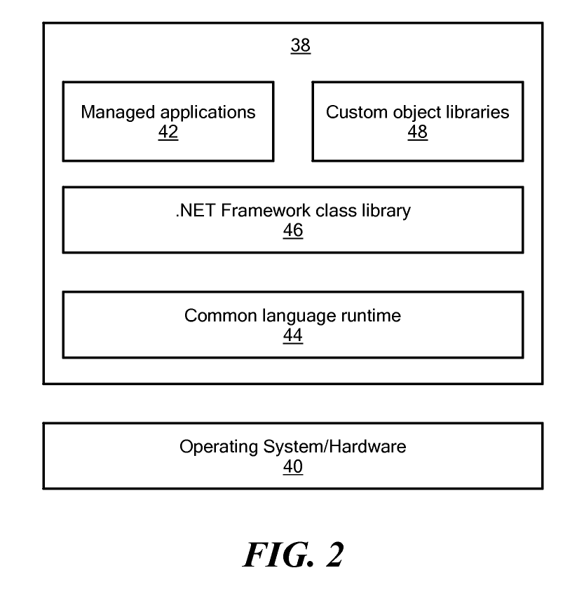

FIG. 2 is a block diagram of an exemplary thread management system 38 constructed in accordance with the principles of the present invention. In accordance with one embodiment, FIG. 2 shows a .NET application in which the invention may be implemented and executed by processor 12 (FIG. 1). For example, the .NET framework may provide a code-execution environment between operating system 40 and a managed application 42. The .NET framework includes two main components: the common language runtime 44 and the .NET framework class library 46. The common language runtime 44 manages the code at execution time and provides core services such as memory management, thread management, and code security check. The .NET framework class library 46 is an object oriented collection of reusable types to facilitate development of custom object libraries 48 and managed applications 42. The .NET framework may also provide a wide variety of application program interface (“API”) calls to manage thread usage.

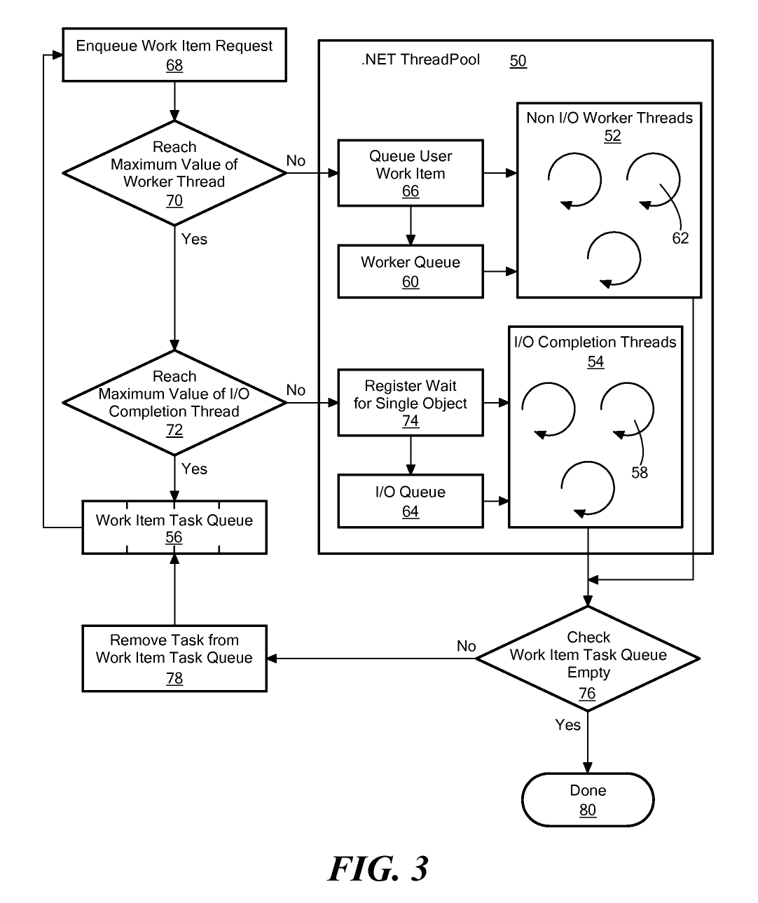

FIG. 3 is a block diagram and process flow of an exemplary thread management system constructed in accordance with the principles of the present invention. In accordance with one embodiment, the thread management system is implemented as part of the common language runtime 44 shown in FIG. 2. The thread management system includes a thread pool 50. A thread pool 50 can have two types of threads, namely first type threads and second type threads. In one embodiment, the thread pool can be a .NET thread pool 50. For example, the first type threads may be non I/O worker threads 52, and the second type threads may be I/O completion threads 54. The threads in the thread pool 50 are used to execute different tasks. For example, there can be different types of tasks, such as a first type task and a second type task. The first type threads 52 can be used to execute one type of task, and the second type threads 54 can be used to execute a second type of task. Additionally, the second type threads 54 can also execute first type tasks. In one embodiment, the first type task and the second type task are stored in the queue 56. Memory 20 (FIG. 1) can store the queue 56, the first type task and the second type task.

In accordance with one embodiment, the number of non I/O worker threads 52 and I/O completion threads 54 is determined in order to balance their workload. A first type task, stored in the queue 56, waits to be executed by a thread in the thread pool 50. The availability of a first type thread is determined, and if none is available, the availability of a second type thread is determined. A processor 12 is used to determine the availability of a first type thread, and if unavailable, the availability of a second type thread is determined. If a second type thread is available, the processor 12 selects the second type thread to execute the first type task. For example, if there are no non I/O worker threads 52 available, the number of available I/O completion threads 54 is determined. If a second type thread is available, for example, an I/O completion thread 58 is available, the second type thread is selected to execute the first type task. Balance is accomplished by creating a secondary task queue: work item task queue 56. There are several advantages of using a secondary task queue 56. First, it may avoid deadlocks in the thread pool 50. Second, it can provide the capability of cancelling any work item request even if it is already queued in the work item task queue 56. Third, it can prioritize a work item request by adding a high priority work item request at the beginning of the work item task queue 56.

In accordance with one embodiment, a .NET thread pool 50 is used to reduce the number of application threads created and to provide management of non I/O worker threads 52 and I/O completion threads 54. Because threads are lightweight processes, they may run within the context of a program and take advantage of the resources allocated for that program and the program's environment. In one embodiment of the present invention, the .NET CreateThread function creates a new thread for a process. The creating thread may specify the starting address of the code that the new thread is to execute. Typically, the starting address is the name of a function defined in the program code.

In one embodiment, applications can queue a work item request in worker queue 60 if the work item request is to be performed by a non I/O worker thread 62, or in I/O queue 64 if the work item request is to be performed by a I/O completion thread 58. Both worker queue 60 and I/O queue 64 can be used to queue up as many work item requests as needed, but only a maximum number of them can be active by entering the .NET thread pool 50 at any given time. The maximum number of active threads is the default size of .NET thread pool 50.

The .NET framework may define an API QueueUserWorkItem 66 call to queue a non I/O work item request for execution. The non I/O work item request will be executed when a non I/O worker thread 62 becomes available. The QueueUserWorkItem 66 API call is commonly used to execute a task in the background at a later point in time using a non I/O worker thread 62 from the .NET thread pool 50.

A non I/O work item request may need to be executed by a thread in the .NET thread pool 50 (step 68). The number of available non I/O worker threads 62 in the .NET thread pool 50 may be determined via the GetAvailableThreads API call at step 70. If there is at least one non I/O worker thread 62 available, the work item request may be added into the .NET thread pool 50 via the QueueUserWorkItem 66 API call. If there are no non I/O worker threads 62 available, the work item request is not immediately added to the worker queue 60, as this may cause deadlock problems.

For example, a problem may arise if all of the non I/O worker threads 52 are busy, especially if all of the non I/O worker threads 52 are to perform a task that requires the help of another non I/O worker thread 62. All of the non I/O worker threads 52 may just keep waiting for a free non I/O worker thread 62 to become available to help finish the task. This situation may cause a deadlock to occur, given that all non I/O worker threads 52 are busy, and new non I/O work item requests for threads are being sent to the worker queue 60 to wait. The non I/O work item requests may never get executed and may wait forever, as none will become available.

In order to solve this problem, in one embodiment, when all of the non I/O worker threads 52 are busy, it is determined whether there are any available I/O completion threads 54 (step 72). If there is an available I/O completion thread 58, then the work item request is added to the .NET pool 50, for example, via the RegisterWaitForSingleObject API call 74. Determining the availability of I/O completion threads 54 (step 72) helps balance the work load between non I/O worker threads 52 and I/O completion threads 54. If there are no I/O completion threads 54 available, then the work item request is queued in work item task queue 56.

The work item request could be a first type task or a second type task. For example, the first type task can be a non I/O work item request and the second type task can be an I/O work item request. There can also be more than one work item request, and if no threads are available to execute the work item request, then the work item request is queued in queue 56. In one embodiment, after a work item request has been executed, a non I/O worker thread 62 or an I/O completion thread 58 may become free. The thread management method monitors the status of the work item task queue 56 (step 76). If the work item task queue 56 holds a work item request, the thread management method will remove the work item request from the work item task queue 56 and will request its execution (step 78). If the work item task queue 56 is empty, i.e. there are no work item requests waiting to be executed, the threads have finished executing all work item requests and the job is done (step 80).

In accordance with one aspect of the present invention, the application can prioritize a work item request in work item task queue 56. As described above and as represented in FIG. 3, the work item task queue 56 holds waiting work item requests. In one embodiment, these work item requests can be sorted by priority. For example, the method can prioritize the queue 56 order of a first type task and a second type task. Thus, the thread management method guarantees that the work item request with the highest priority will get executed by the next available thread in the .NET thread pool 50. The work item task queue 56 also provides the ability to cancel any waiting work item request in the work item task queue 56. As such, a first type task or a second type task stored in the queue 56 can be deleted.

In yet another embodiment, the processor 12 prioritizes the priority order of a first type task or a second type task in the queue 56. The processor 12 can also delete the first type task or the second type task stored in the queue 56. In addition, the processor 12 queues the first type task or the second type task when there are no threads available in the .Net thread pool 50 to execute either the first type task or the second type task.

In this document, the terms “computer program medium,” “computer usable medium,” and “computer readable medium” are used to generally refer to media such as main memory 20 and secondary memory 22, removable storage drive 26, a hard disk installed in hard disk drive 24, and signals. These computer program products are means for providing software. The computer readable medium allows the computer system to read data, instructions, messages or message packets, and other computer readable information from the computer readable medium. The computer readable medium, for example, may include non-volatile memory, such as floppy, ROM, flash memory, disk drive memory, CD-ROM, and other permanent storage. It is useful, for example, for transporting information, such as data and computer instructions, between other devices within system 10. Furthermore, the computer readable medium may comprise computer readable information in a transitory state medium such as a network link and/or a network interface, including a wired network or a wireless network that allows a computer to read such computer readable information.

The present invention advantageously provides a system and method to manage thread use. Such method allows balance of the work load of non I/O worker threads 52 and I/O completion threads 54, while also facilitating work item request prioritization and cancellation. In accordance with an embodiment of the present invention, deadlocks may be avoided, even when non I/O worker threads 52 and I/O completion threads 54 are unavailable. For example, when non I/O worker threads 52 are unavailable, and an I/O completion thread 58 is available, the method uses the available I/O completion thread 58 to execute the work item request regardless of whether it is a non I/O work item request or an I/O work item request. By queuing the work item request in a work item task queue 56 when there are no threads available in the .NET thread pool 50, deadlocks may be avoided. As discussed above in detail, prioritization and cancellation of work item requests can be provided.

The present invention can be realized in hardware, software, or a combination of hardware and software. Any kind of computing system, or other apparatus adapted for carrying out the methods described herein, is suited to perform the functions described herein.

A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product that comprises all the features enabling the implementation of the methods described herein, and which, when loaded in a computing system is able to carry out these methods. Storage medium refers to any volatile or non-volatile computer readable storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method for managing a thread pool, the thread pool comprising a plurality of first type threads and a plurality of second type threads, said method comprising:
storing a first type task and a second type task in a queue, the second type task executable by at least one of the plurality of second type threads;
determining an availability of at least one of the plurality of first type threads;
determining availability of at least one of the plurality of second type threads if at least one of the plurality of first type threads is unavailable; and
selecting at least one available second type thread to execute the first type task.

2. The method of claim 1, further comprising prioritizing an order of at least one of the first type task and the second type task in the queue.

3. The method of claim 1, further comprising deleting at least one of the first type task and the second type task stored in the queue.

4. The method of claim 1, wherein the plurality of first type threads comprises non I/O worker threads.

5. The method of claim 1, wherein the plurality of second type threads comprises I/O completion threads.

6. The method of claim 1, further comprising queuing the first type task and the second type task in the queue when none of the plurality of first type threads and the plurality of second type threads are available.

7. The method of claim 1, wherein the managing the thread pool comprises determining if the queue contains one of the first type task and the second type task.

8. The method of claim 1, wherein the thread pool is a .NET thread pool.

9. A system for managing a thread pool, the thread pool comprising a plurality of first type threads and a plurality of second type threads, the system comprising:
a memory having:
a queue, a first type task, and a second type task, the first type task and the second type task being storable in the queue, the second type task executable by at least one of the plurality of second type threads; and
a processor in data communication with the memory, the processor operating to:
determine availability of at least one of the plurality of first type threads;
determine availability of at least one of the plurality of second type threads if at least one of the plurality of first type threads is unavailable; and
select at least one available second type thread to execute the first type task.

10. The system of claim 7, wherein the processor prioritizes an order of at least one of the first type task and the second type task in the queue.

11. The system of claim 7, wherein the processor deletes at least one of the first type task and the second type task stored in the queue.

12. The system of claim 7, wherein the plurality of first type threads comprises non I/O worker threads.

13. The system of claim 7, wherein the plurality of second type threads comprises I/O completion threads.

14. The system of claim 7, wherein the processor queues the first type task and the second type task in the queue when none of the plurality of first type threads and the plurality of second type threads are available.

15. The method of claim 1, wherein the managing the thread pool comprises determining if the queue contains one of the first type task and the second type task.

16. The method of claim 1, wherein the thread pool is a .NET thread pool.

17. An apparatus for managing a thread pool, the apparatus comprising:
a memory having a queue;
a processor in data communication with the memory, the processor configured to:
store a plurality of first type threads and a plurality of second type threads in the memory;
store a first type task and a second type task in the queue, the second type task executable by at least one of the plurality of second type threads;
determine availability of at least one of the plurality of first type threads;
determine availability of at least one of the plurality of second type threads if at least one of the plurality of first type threads is unavailable;
select at least one available second type thread to execute the first type task.

18. The apparatus of claim 17, wherein the processor prioritizes an order of at least one of the first type task and the second type task in the queue.

19. The apparatus of claim 17, wherein the processor deletes at least one of the first type task and the second type task stored in the queue.

20. The apparatus of claim 17, wherein the plurality of first type threads comprises non I/O worker threads.
